(19) United States
(12) Patent Application Publication
(10) Pub. No.: US 2015/0145731 A1
(43) Pub. Date: May 28, 2015

(54) ELECTRONIC DEVICE

(71) Applicants: INVENTEC CORPORATION, Taipei (TW); Inventec (Pudong) Technology Corporation, Shanghai (CN)

(72) Inventors: Wei-Chang JHANG, Taipei (TW); Chun-Sheng WU, Taipei (TW); Chih-Cheng LI, Taipei (TW)

(73) Assignees: INVENTEC CORPORATION, Taipei (TW); Inventec (Pudong) Technology Corporation, Shanghai (CN)

(21) Appl. No.: 14/242,558

(22) Filed: Apr. 1, 2014

(30) Foreign Application Priority Data
Nov. 22, 2013 (CN) 201310597424.6

(51) Int. Cl. H01Q 1/24

(52) U.S. Cl. CPC H01Q 1/243
USPC 343/702

(57) ABSTRACT

The disclosure relates to an electronic device including a metallic shell. The electronic device is characterized in that the metallic shell has a groove. The groove separates the metallic shell into a main portion and an antenna portion. The main portion and the antenna are electrically insulated from each other.

### CROSS-REFERENCE TO RELATED APPLICATIONS

This non-provisional application claims priority under 35 U.S.C. §119(a) on Patent Application No(s). 201310597424.6 filed in China on Nov. 22, 2013, the entire contents of which are hereby incorporated by reference.

### BACKGROUND OF THE INVENTION

1. Technical Field of the Invention

The disclosure relates to an electronic device, and more particularly, to an electronic device including a metallic shell having a groove.

2. Description of the Related Art

With the development of the technology, the demand for electronic devices has been increased. For instance, electronic devices should have more functions and more sleek designs. Take laptops as an example, the shells of the laptops are made of plastic rather than metal so as to prevent the metallic shell from shielding signals emitted from antennas. However, the appearance of the plastic shells and the metallic shells are not identical, so that the appearance of the laptops still needs to be improved.

### SUMMARY OF THE INVENTION

According to an embodiment, an electronic device includes a metallic shell. The electronic device is characterized in that the metallic shell has a groove. The groove separates the metallic shell into a main portion and an antenna portion. The main portion and the antenna portion are electrically insulated from each other.

### BRIEF DESCRIPTION OF THE DRAWINGS

The present disclosure will become more fully understood from the detailed description given hereinbelow, along with the accompanying drawings which are for illustration only, thus are not limitative of the present disclosure, and wherein:

FIG. 1 is a schematic view of part of an electronic device according to an embodiment of the disclosure;

FIG. 2 is another schematic view of part of the electronic device of FIG. 1; and

FIG. 3 is a schematic view of part of an electronic device according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

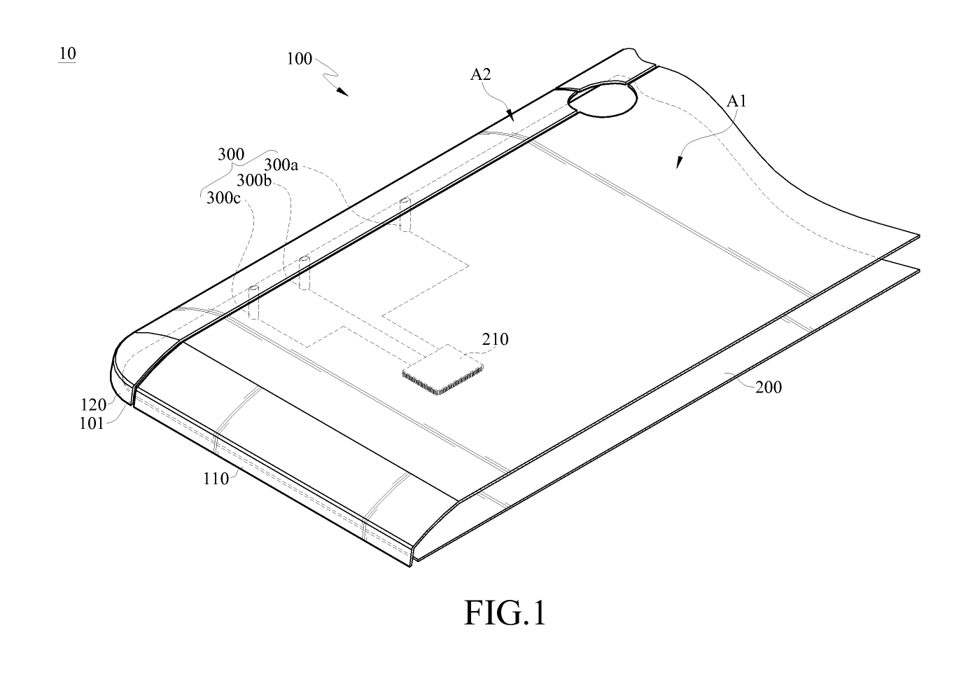

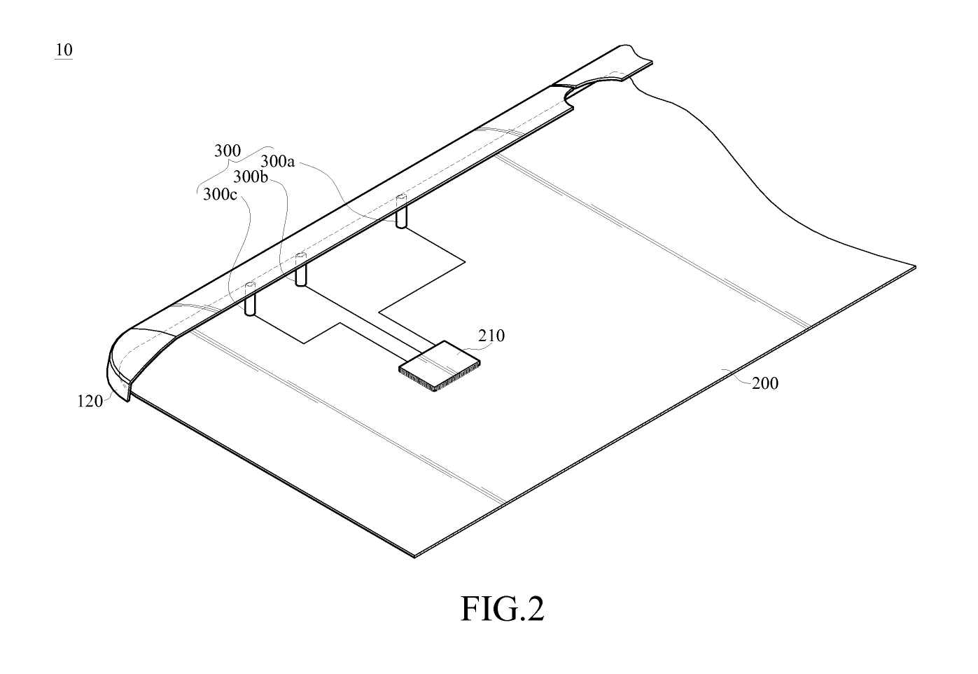

First, please refer to FIG. 1 and FIG. 2. FIG. 1 is a schematic view of part of an electronic device according to an embodiment of the disclosure. FIG. 2 is another schematic view of part of the electronic device of FIG. 1. As shown in the figures, the electronic device 10 of the disclosure includes a metallic shell 100. In the following descriptions, the electronic device 10 is described as a laptop, but the disclosure is not limited thereto.

The metallic shell 100 has a groove 101. Further, the groove 101 separates the metallic shell 100 into a main portion 110 and an antenna portion 120. The main portion 110 and the antenna portion 120 are electrically insulated from each other. Thus, the main portion 110 and the antenna portion 120 are disposed at two sides of the groove 101 respectively, as well as it is not conductive between the main portion 110 and the antenna portion 120.

Moreover, since the main portion 110 and the antenna portion 120 are electrically insulated from each other, the metallic shell 100 can be an exterior unit of the electronic device 10. Also, the antenna portion 120 of the metallic shell 100 is adapted for emitting signals or receiving signals. Thereby, the appearance of the exterior unit (the metallic shell 100) of the electronic device 10 is more consistent and has a more sleek design while the metallic shell 100 satisfies the functional requirement of the electronic device 10.

In this embodiment, the main portion 110 has a first outer surface A1, and the antenna portion 120 has a second outer surface A2. The area of the first outer surface A1 is greater than the area of the second outer surface A2.

In this and some other embodiments, the electronic device 10 further comprises a circuit board 200 and at least a conductive body 300. In the following descriptions, the quantity of the conductive bodies 300 is three, but the disclosure is not limited thereto.

The circuit board 200 has an antenna circuit 210. The circuit board 200 is disposed inside the metallic shell 100. One end of the conductive body 300 is electrically connected with the antenna portion 120 of the metallic shell 100. The other end of the conductive body 300 is electrically connected with the antenna circuit 210 of the circuit board 200. Therefore, the antenna portion 120 of the metallic shell 100 is electrically connected with the antenna circuit 210 of the circuit board 200 through the conductive body 300 so that the signals generated by the antenna circuit 210 can be emitted to or received from other electronic device (not shown).

In this embodiment, one of the three conductive bodies 300 has a feed-in terminal 300a, the other two conductive bodies 300 have a first ground terminal 300b and a second ground terminal 300c, respectively. The antenna circuit 210 is electrically connected with the feed-in terminal 300a and is selectively electrically connected with the first ground terminals 300b or the second ground terminal 300c. Thus, certain hardware or software of the electronic device 10 can control the antenna circuit 210 to electrically connect with the feed-in terminal 300a and the first ground terminal 300b or to electrically connect with the feed-in terminal 300a and the second ground terminal 300c.

Moreover, the distance between the first ground terminal 300b and the first feed-in terminal 300a is different than the distance between the second ground terminal 300c and the first feed-in terminal 300a. When the antenna circuit 210 is electrically connected with the first ground terminal 300b, the antenna circuit 210 has a first frequency band. When the antenna circuit 210 is electrically connected with the second ground terminal 300c, the antenna circuit 210 has a second frequency band. The bandwidth of the first frequency band is greater than the bandwidth of the second frequency band. In other words, the whole antenna module has two different frequency bands when the antenna circuit 210 is electrically connected with the first ground terminal 300b or the second ground terminal 300c through the command of certain hardware or software of the electronic device 10. Therefore, the antenna circuit 210 is configured for providing multiple frequency bands for the users. In this embodiment, the quantity of the conductive bodies 300 is three so that the antenna circuit 210 has two frequency bands, but the quantity of the conductive bodies is not limited to the disclosure. Accordingly, the antenna module can have more frequency bands by increasing the quantity of the conductive bodies 300.

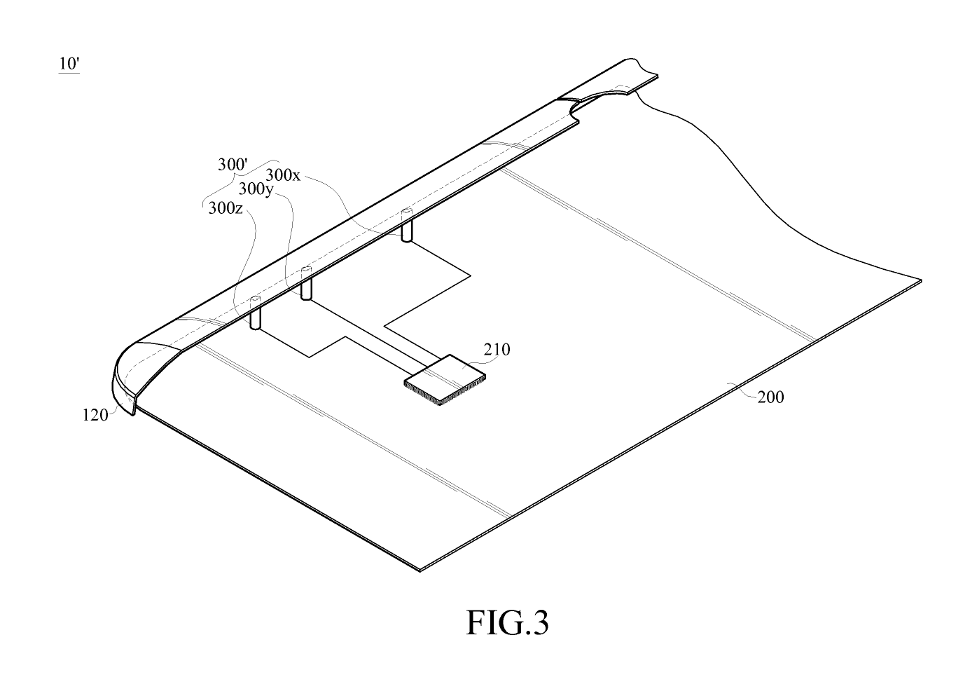

In this embodiment, the conductive body 300 has a feed-in terminal and two ground terminals, but the disclosure is not limited thereto. In some other embodiments, the conductive body may have other quantities of the feed-in terminals or the ground terminals. For instance, one feed-in terminal and one ground terminal. In other words, the quantities of the feed-in terminals and the ground terminals of the conductive body do not limit the disclosure. Please refer to FIG. 3, which is a schematic view of part of an electronic device according to another embodiment of the disclosure. The embodiment of FIG. 3 is similar with the embodiment of FIGS. 1 and 2, wherein identical symbols represent the identical or similar units, so those are not described in detail.

In this embodiment, one of the three conductive bodies 300′ of the electronic device 10′ has a ground terminal 300y, and the other two conductive bodies 300′ have a first feed-in terminal 300x and a second feed-in terminal 300z, respectively. The antenna circuit 210 is electrically connected with the ground terminal 300y and is selectively electrically connected with the first feed-in terminal 300x or the second feed-in terminal 300z. Thus, certain hardware or software of the electronic device 10′ can control the antenna circuit 210 to electrically connect with the ground terminal 300y and the first feed-in terminal 300x or to electrically connect with the ground terminal 300y and the second feed-in terminal 300z.

Moreover, the distance between the first feed-in terminal 300x and the ground terminal 300y is different than the distance between the second feed-in terminal 300z and the first ground terminal 300y. When the antenna circuit 210 is electrically connected with the first feed-in terminal 300x, the antenna circuit 210 has a first frequency band. When the antenna circuit 210 is electrically connected with the second feed-in terminal 300z, the antenna circuit 210 has a second frequency band. The bandwidth of the first frequency band is greater than the bandwidth of the second frequency band. In other words, the whole antenna module has two different frequency bands when the antenna circuit 210 is electrically connected with the first feed-in terminal 300x or the second feed-in terminal 300z through the command of certain hardware or software of the electronic device 10′. Therefore, the antenna circuit 210 can provide multiple frequency bands for the users. In this embodiment, the quantity of the conductive bodies 300′ is three so that the antenna circuit 210 has two frequency bands, but the quantity of the conductive bodies is not limited to the disclosure. Accordingly, the antenna module may have more frequency bands by increasing the quantity of the conductive bodies 300 (or 300′); the antenna module may have one frequency band by decreasing the quantity of the conductive bodies 300 (or 300′) (e.g. the quantity of the conductive body's is two, one of the conductive body's is a feed-in terminal, the other conductive body is a ground terminal, and the antenna circuit is electrically connected with the feed-in terminal and the ground terminal).

According to the electronic device of the disclosure, since the main portion and the antenna portion of the metallic shell are electrically insulated from each other, the metallic shell can be an exterior unit of the electronic device. Also, the metallic shell can emit signals or receive signals by the antenna portion. Thereby, the appearance of the exterior unit of the electronic device is more consistent and has a more sleek design while the metallic shell 100 satisfies the functional requirement of the electronic device.

In addition, since multiple conductive bodies can be disposed in the electronic device, and each of the conductive bodies has multiple feed-in terminals and/or ground terminals, and the distances between the feed-in terminals and the ground terminals are different from each other. Therefore, the antenna circuit may have different frequency bands having different bandwidths by the antenna circuit being electrically connected with different feed-in terminals and/or different ground terminals. Thus, the antenna circuit can provide the users with multiple bandwidths.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. An electronic device, including a metallic shell, characterized in that the metallic shell has a groove, the groove separating the metallic shell into a main portion and an antenna portion, and the main portion and the antenna being electrically insulated from each other.

2. The electronic device according to claim 1, wherein the area of an outer surface of the main portion is greater than the area of an outer surface of the antenna portion.

3. The electronic device according to claim 1, further comprising a circuit board and a first conductive body, wherein the circuit board includes an antenna circuit, the circuit is disposed inside the metallic shell, one end of the first conductive body is electrically connected with the antenna portion of the metallic shell, the other end of the first conductive body is electrically connected with the antenna circuit of the circuit board.

4. The electronic device according to claim 3, further comprising a second conductive body, wherein the second conductive body has a first feed-in terminal, the first conductive body has a first ground terminal, and the antenna circuit is electrically connected with the first feed-in terminal and the first ground terminal.

5. The electronic device according to claim 3, further comprising a second conductive body and a third conductive body, wherein the second conductive body has a first feed-in terminal, the first conductive body has a first ground terminal, the third conductive body has a second ground terminal, the antenna circuit is electrically connected with the first feed-in terminal and is selectively electrically connected with the first ground terminal or the second ground terminal.

6. The electronic device according to claim 5, wherein when the antenna circuit is electrically connected with the first ground terminal, the antenna circuit has a first frequency band, when the antenna circuit is electrically connected with the second ground terminal, the antenna circuit has a second frequency band, the bandwidth of the first frequency band is different with the bandwidth of the second frequency band.

7. The electronic device according to claim 5, wherein the distance between the first feed-in terminal and the first ground terminal is different than the distance between the first feed-in terminal and the second ground terminal.

8. The electronic device according to claim 3, further comprising a second conductive body and a third conductive body, wherein the second conductive body has a first feed-in terminal, the third conductive body has a second feed-in terminal, the first conductive body has a first ground terminal, the antenna circuit is electrically connected with the first ground terminal and is selectively electrically connected with the first feed-in terminal or the second feed-in terminal.

9. The electronic device according to claim 8, wherein, when the antenna circuit is electrically connected with the first feed-in terminal, the antenna circuit has a first frequency band, when the antenna circuit is electrically connected with the second feed-in terminal, the antenna circuit has a second frequency band, the bandwidth of the first frequency band is different with the bandwidth of the second frequency band.

10. The electronic device according to claim 8, wherein the distance between the first feed-in terminal and the first ground terminal is different than the distance between the second feed-in terminal and the first ground terminal.
